(19) United States
(12) Patent Application Publication
(10) Pub. No.: US 2015/0006645 A1
(43) Pub. Date: Jan. 1, 2015

(54) SOCIAL SHARING OF VIDEO CLIPS

(71) Applicants: Jerry Oh, Santa Clara, CA (US); William Jackson, Palo Alto, CA (US); Lance T. Peterson, San Jose, CA (US); Curtis C. Simonson, San Jose, CA (US)

(72) Inventors: Jerry Oh, Santa Clara, CA (US); William Jackson, Palo Alto, CA (US); Lance T. Peterson, San Jose, CA (US); Curtis C. Simonson, San Jose, CA (US)

(21) Appl. No.: 13/931,373

(22) Filed: Jun. 28, 2013

(51) Int. Cl. H04L 29/06

(52) U.S. Cl. CPC H04L 65/60
USPC 709/206; 709/217; 715/753

(57) ABSTRACT

In embodiments, apparatuses, methods and storage media are described that are associated with content distribution. In embodiments, a user device may transmit content to a display. During the presentation of the content on the display device, a first user may issue a command to share a portion of the content with a second user. Based on the command, the user device may facilitate the transmission of an indication to the second user that the portion is available for viewing by the second user.

### TECHNICAL FIELD

The present disclosure relates to the field of data processing, and specifically to sharing of video content.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

Advances in computing, networking and related technologies have led to proliferation in the availability of multimedia content, and the manners in which the content is consumed. Today, multimedia content may be made available from fixed medium (e.g., Digital Versatile Disk (DVD)), broadcast, cable operators, satellite channels, Internet, and so forth. Users may consume content with a television set, a laptop or desktop computer, a tablet, a smartphone, or other devices of the like. In many cases, content may be shared by a first user based on a recommendation by the first user such as a recommendation that a second user watch a specific movie or a specific television show. However, the second user may not be able or willing to watch the entire movie or television show.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an arrangement for content distribution and consumption, in accordance with various embodiments.

FIG. 2 illustrates an example process of sharing, by a first user, a portion of content with a second user, in accordance with various embodiments.

FIG. 3 illustrates an example process that may be performed in a server to share, by a first user, a portion of content with a second user, in accordance with various embodiments.

FIG. 4 illustrates an example process for a second user to access a shared portion of content.

FIG. 5 illustrates an example computing environment suitable for practicing the disclosure, in accordance with various embodiments.

FIG. 6 illustrates an example storage medium with instructions configured to enable an apparatus to practice the present disclosure, in accordance with various embodiments.

### DETAILED DESCRIPTION

Apparatuses, methods and storage media associated with content distribution and/or consumption are disclosed herein. In embodiments, content may be delivered to a first user. While viewing the content, or while the content is paused, the first user may issue a command such as a gesture-based, voice-based, or input device-based command. The command may be related to sharing a portion of the current content with a second user or a social network. In some cases, the second user may be geographically remote from the first user. Based on that command, the content distribution or consumption device may identify the portion of the current content and transmit an indication to a second user. Based on the indication, the second user may be able to access and view the portion of the content.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

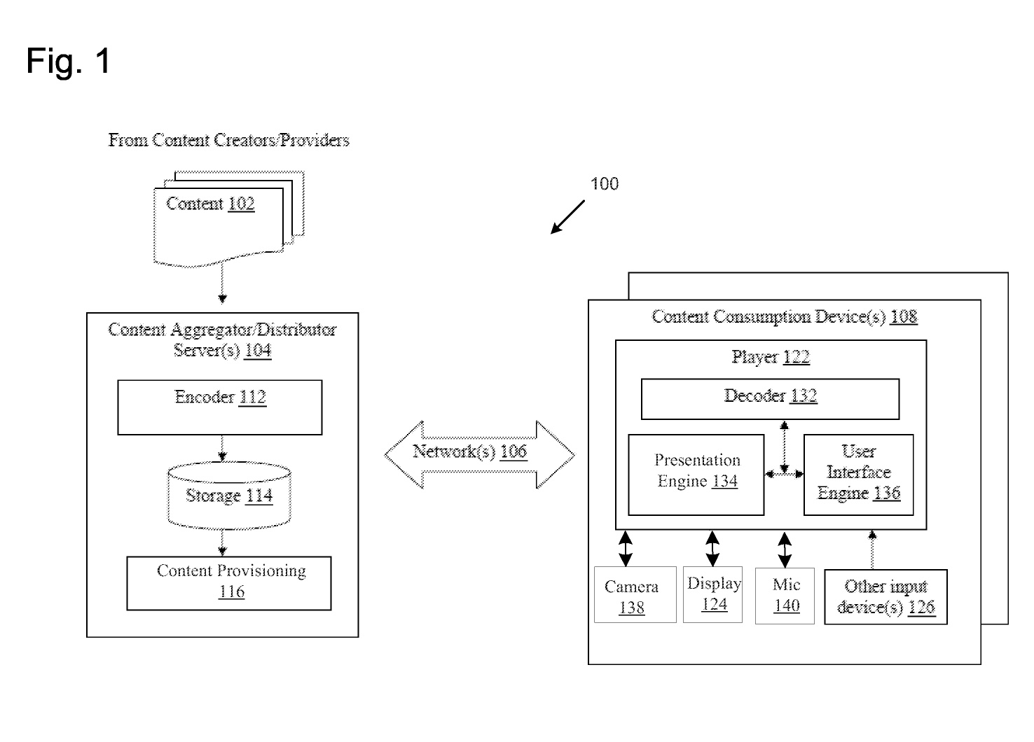

Referring now to FIG. 1, an arrangement for content distribution and consumption, in accordance with various embodiments, is illustrated. As shown, in embodiments, arrangement 100 for distribution and consumption of content 102 may include a number of content consumption device(s) 108 coupled with one or more content aggregator/distributor servers 104 via one or more networks 106. Content aggregator/distributor servers 104 may be configured to aggregate and distribute content 102 to content consumption device(s) 108 for consumption, via one or more networks 106.

In embodiments, as shown, content aggregator/distributor servers 104 may include encoder 112, storage 114 and content provisioning 116, which may be coupled to each other as shown. Encoder 112 may be configured to encode content 102 from various content providers, and storage 114 may be configured to store encoded content. Content provisioning 116 may be configured to selectively retrieve and provide encoded content to the various content consumption device(s) 108 in response to requests from the various content consumption device(s) 108. Content 102 may be multimedia content of various types, having one or more of video, audio, and/or closed captions, from a variety of content creators and/or providers. Examples of content 102 may include, but are not limited to, movies, TV programming, user created content (such as YouTube video, iReporter video), music albums/titles/pieces, and so forth. Examples of content creators and/or providers may include, but are not limited to, movie studios/distributors, television programmers, television broadcasters, satellite programming broadcasters, cable operators, online users, and so forth.

In embodiments, for efficiency of operation, encoder 112 may be configured to encode the various content 102, typically in different encoding formats, into a subset of one or more common encoding formats. However, encoder 112 may be configured to nonetheless maintain indices or cross-references to the corresponding content in their original encoding formats. Similarly, for flexibility of operation, encoder 112 may encode or otherwise process each or selected ones of content 102 into multiple versions of different quality of service (QoS) levels. The different versions or levels may provide different resolutions, different bitrates, and/or different frame rates for transmission and/or playing, collectively generally referred to as QoS parameters. In various embodiments, the encoder 112 may publish, or otherwise make available, information on the available different resolutions, different bitrates, and/or different frame rates. For example, the encoder 112 may publish bitrates at which it may provide video or audio content to the content consumption device(s) 108. Encoding of audio data may be performed in accordance with, e.g., but are not limited to, the MP3 standard, promulgated by the Moving Picture Experts Group (MPEG). Encoding of video data may be performed in accordance with, e.g., but are not limited to, the H264 standard, promulgated by the International Telecommunication Unit (ITU) Video Coding Experts Group (VCEG). Encoder 112 may include one or more computing devices configured to perform content portioning, encoding, and/or transcoding, such as described herein.

Storage 114 may be temporal and/or persistent storage of any type, including, but not limited to, volatile and non-volatile memory, optical, magnetic and/or solid state mass storage, and so forth. Volatile memory may include, but are not limited to, static and/or dynamic random access memory. Non-volatile memory may include, but are not limited to, electrically erasable programmable read-only memory, phase change memory, resistive memory, and so forth.

Content provisioning 116 may, in various embodiments, be configured to provide encoded content as discrete files and/or as continuous streams of encoded content. Content provisioning 116 may be configured to transmit the encoded audio/video data (and closed captions, if provided) in accordance with any one of a number of streaming and/or transmission protocols. Streaming protocols may include the MPEG Dynamic Adaptive Streaming over Hypertext Transfer Protocol (MPEG-DASH) protocol defined ins ISO/IEC 23009-1 (04-01-2012), and/or some other streaming protocol. Transmission protocols may include, but are not limited to, the transmission control protocol (TCP), user datagram protocol (UDP), and so forth. Networks 106 may be any combinations of private and/or public, wired and/or wireless, local and/or wide area networks. Private networks may include, e.g., but are not limited to, enterprise networks. Public networks, may include, e.g., but is not limited to the Internet. Wired networks, may include, e.g., but are not limited to, Ethernet networks. Wireless networks, may include, e.g., but are not limited to, Wi-Fi, or 3G/4G networks. It would be appreciated that at the content distribution end, networks 106 may include one or more local area networks with gateways and firewalls, through which content aggregator/distributor servers 104 go through to communicate with content consumption device(s) 108. Similarly, at the content consumption end, networks 106 may include base stations and/or access points, through which content consumption device(s) 108 communicate with content aggregator/distributor servers 104. In between the two ends may be any number of network routers, switches and other networking equipment of the like. However, for ease of understanding, these gateways, firewalls, routers, switches, base stations, access points and the like are not shown.

In embodiments, as shown, a content consumption device 108 may include player 122, display 124 and user input device 126. Player 122 may be configured to receive streamed content, decode and recover the content from the content stream, and present the recovered content on display 124, in response to user selections/inputs from user input device 126. The content consumption device 108 may further include or otherwise be coupled with a camera 138 configured to capture images. In embodiments, the camera 138 may be configured to perform analog or digital capture of images including still images or moving images. In some embodiments, the content consumption device 108 may further include or otherwise be coupled with a microphone 140 configured to capture sounds. In embodiments, the microphone 140 may be configured to perform analog or digital capture of sounds or noises from a user or other noise-emitter within range of the microphone 140.

In embodiments, player 122 may include decoder 132, presentation engine 134 and user interface engine 136. Decoder 132 may be configured to receive streamed content, decode, and recover the content 102 from the content stream. Presentation engine 134 may be configured to present the recovered content on display 124, in response to user selections/inputs. In various embodiments, decoder 132 and/or presentation engine 134 may be configured to present audio and/or video content to a user that has been encoded using varying encoding control variable settings in a substantially seamless manner. Thus, in various embodiments, the decoder 132 and/or presentation engine 134 may be configured to present two portions of content 102 that vary in resolution, frame rate, and/or compression settings without interrupting presentation of the content 102. User interface engine 136 may be configured to receive the user selections/inputs from a user.

While shown as part of a content consumption device 108, display 124, user input device(s) 126, microphone 140, and/or camera 138 may be stand-alone devices or integrated, for different embodiments of content consumption device(s) 108. For example, for a television arrangement, display 124 may be a stand-alone television set, Liquid Crystal Display (LCD), Plasma and the like, while player 122 may be part of a separate set-top set, and other user input device 126 may be a separate remote control or keyboard. A camera 138 or microphone 140 may be integrated with one or more of the display 124, the player 122, or even the user input device 126. Similarly, for a desktop computer arrangement, player 122, display 124, other user input device(s) 126, camera 138 and microphone 140 may all be separate stand-alone units. On the other hand, for a laptop, ultrabook, tablet, or smartphone arrangement, display 124 may be a touch sensitive display screen that includes other user input device(s) 126, and player 122 may be a computing platform with a soft keyboard that also include one of the user input device(s) 126. Further, display 124, player 122, camera 138, and microphone 140 may be integrated within a single form factor. Similarly, for a smartphone arrangement, player 122, display 124, other user input device(s) 126, camera 138, and microphone 140 may be likewise integrated.

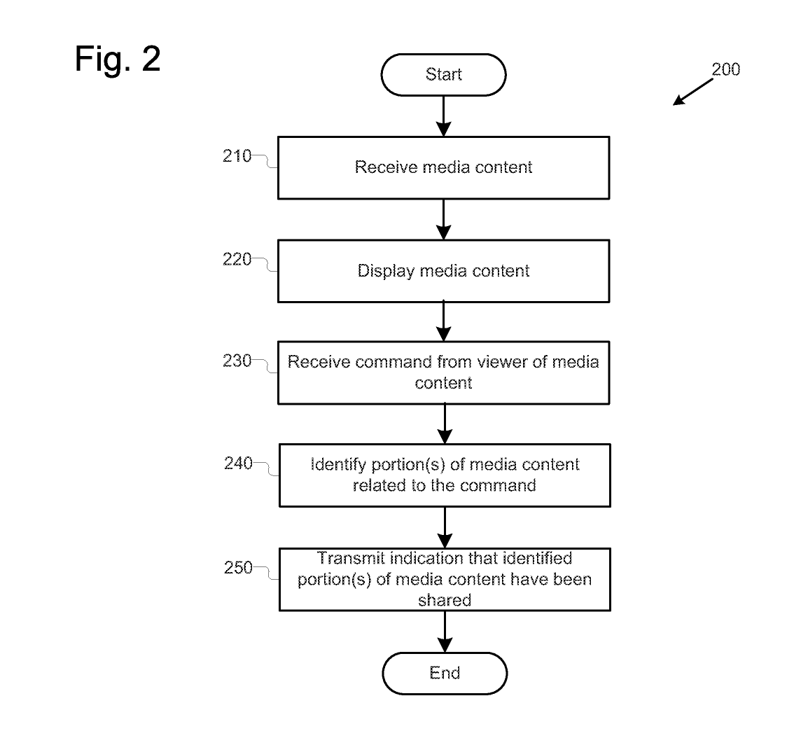

FIG. 2 depicts an example process 200 for sharing portions of media content such as content 102. Specifically, the content 102 may be comprised of a plurality of portions, and the process 200 may facilitate sharing, by a first user, one or more of the portions of the plurality of portions with a second user.

Initially, a device such as content consumption device 108, and specifically player 122 and/or the user interface engine 136 of the player 122, may receive content 102 at 210. The content 102 may then be displayed, for example on display 124, at 220. In some embodiments, a portion of content 102 may be received at a time which is relatively close to display of the portion of content 102 and may not be retained in its entirety on the content consumption device 108. In embodiments, this may be similar to, or referred to, as “streamed” content. In other embodiments, the entirety of the content 102 may be received by the content consumption device 108 prior to display of any portion of the content 102. In some embodiments, the content 102 may be partitioned or otherwise demarcated into specific predetermined portions or segments at encoding, for example by encoder 112 prior to transfer over the network(s) 106 to a client consumption device 108. In other embodiments, the content 102 may be separated into specific predetermined portions or segments by the decoder 132 during decoding of data received from the content aggregator/distributor server(s) 104. In other embodiments, one or more elements of the network(s) 106 may separate the content 102 into one or more predetermined portions or segments.

During display of the content 102 to a viewer of the content 102, for example by display 124, the content consumption device 108 may receive a command from the viewer at 230. In some embodiments, the command may include one or more command criteria, as described below.

In embodiments, the command may be a spoken command that is received by the content consumption device 108 using microphone 140. In some embodiments, the spoken command may include a command criteria.

In one embodiment, a command criteria may be an identification term to identify a portion of the content 102 based on context. Examples of a command using an identification term include “share that clip,” “share that joke,” “share the current clip,” or some other command using an identification term.

In some embodiments, a command criteria may be a time-based term to identify the portion of the content 102 based on time. Examples of a command using a time-based term may include “share the last ten seconds,” “share the last 30 seconds,” or some other command using a time-based term. In other embodiments, the time-based term may be based on a time-stamp of where the portion of content resides within the content. For example, the time-based term may be “share between time-stamp 30 seconds and time-stamp 43 seconds.”

In some embodiments, a command criteria may be a target term such as a user's name, a social network, or some other target term. Examples of a command using a target term may include “share that joke with Sam,” “share that joke with [social network],” or some other command using a target term.

In some embodiments, and as discussed above, the content 102 may have already been separated into predetermined portions or segments either at encoding, transfer, or decoding. Therefore, a command criteria such as a time-based term or an identification term may be unnecessary. The above noted examples are only examples, and in other embodiments the specific terms or syntax used may be different.

In other embodiments, the command may be input using a visual cue to the camera 138 of content consumption device 108. For example, a specific gesture or motion by the viewer may be identified by the camera 138 and indicate that the user desires to share a portion of the content 102. In some embodiments, different gestures may be recognized by the camera 138 such that different gestures indicate different command criteria as described above, for example an identification term, a time-based term, and/or a target term. In other embodiments, the command may not have a command criteria such as an identification term and/or a time-based term, and instead the portion of content 102 may be predetermined.

In some embodiments, the command may be input by the user using a user input device such as one or more of user input device(s) 126 described above. Specifically, the user may press a certain button or otherwise activate the user input device 126. As noted above, the command may include one or more command criteria such as an identification term, a time-based term, and/or a target identifier.

In some embodiments, the command may comprise a plurality of commands, which may have one or more different command criteria. For example, in one embodiment a user may provide an initial command which may include, for example, a command criteria such as an identification term. Playback of the content 102 may pause and the user may then provide further commands or command criteria such as a target identifier via a user input device 126. Other embodiments may include other combinations of one or more of the command criteria discussed above, or a command criteria in combination with a predetermined portion of the content 102. Additionally, the command criteria described above are examples of such command criteria, and a command may include additional or alternative command criteria.

After receiving the command, the content consumption device 108 may identify the portion of content 102 related to the command at 240. For example, the content consumption device 108, and specifically the user interface engine 136, may determine whether the command contains one or more command criteria as described above. Based on the one or more command criteria, for example an identification term or time-based term, the content consumption device 108 may identify the portion of the content 102. If an identification term or time-based term is not present, then the content consumption device 108 may be programmed, either by the user or by some entity, to identify either the currently playing predetermined portion of the content 102, or the predetermined portion of the content 102 immediately preceding the currently playing predetermined portion of the content 102. In some embodiments, the portion of the content may have a length within a pre-defined range, such as, for example, between 5 and 30 seconds.

After identifying the portion of content 102 at 240, the content consumption device 108 may transmit an indication that the viewer has shared the portion of content 102 with a target such as a second user or a social network. Specifically, the content consumption device 108 may transmit the indication to the content aggregator/distributor server(s) 104 or some other server. In other embodiments, the content consumption device 108 may transmit the indication directly to an entity of the social network such as a server of the social network. In other embodiments, the content consumption device 108 may transmit the indication directly to the second user, or to a device of the second user. In embodiments, the indication may include, or be based on, one or more of the command criteria described above such as an identification term, a time-based term, and/or a target identifier. In other words, the indication may include an identification of the specific content based on context such as indication of a certain segment or joke if an identification term is used. If a time-based term is used in the command, then the time-based term may be the basis for the indication to include one or more of a start time of the portion, an end time of the portion, and a duration of the portion. Alternatively, if the indication is related to a predetermined portion of the content, then the predetermined portion of the content may be identified using one or more of an identification tag, a start time of the portion, an end time of the portion, and a duration of the portion. If a target identifier is included in the command, then the indication may include an identifier of a person or entity with which the content is being shared. In some embodiments, the indication may include one or more of an identifier of the first user, a time/date stamp based on when the first user shared the content, and/or a location stamp regarding where the first user shared the location from.

Although the process 200 of FIG. 2 is described with respect to a content consumption device 108, in other embodiments aspects of the process 200 may be performed by another entity such as a content aggregator/distributor server 104 or some other server. For example, in some embodiments the content consumption device 108 may receive the command from a user, and transmit the command over a network 106 to a content aggregator/distributor server 104 such that the content aggregator/distributor server 104 receives the command at 230. Then, as described above, the content aggregator/distributor server 104 may analyze the command to identify one or more portion(s) of content 102 related to the command at 240. Finally, the content aggregator/distributor server 104 may transmit an indication to a second user or some other entity at 250. In other embodiments, different aspects of the process 200 may be performed by different entities.

In some embodiments, different elements of the process 200 may be performed in a different order. For example, in some embodiments the command may be received at 230 prior to display of the media content at 220. For example, as an individual begins viewing the media content, the individual may already know a specific of the content which they would like to share, and so they may issue the command prior to viewing the portion. In some embodiments, the command may be received after the conclusion of presentation of the content. For example, the content may end and then an individual may issue the command with respect to a given time portion of other portion of the content.

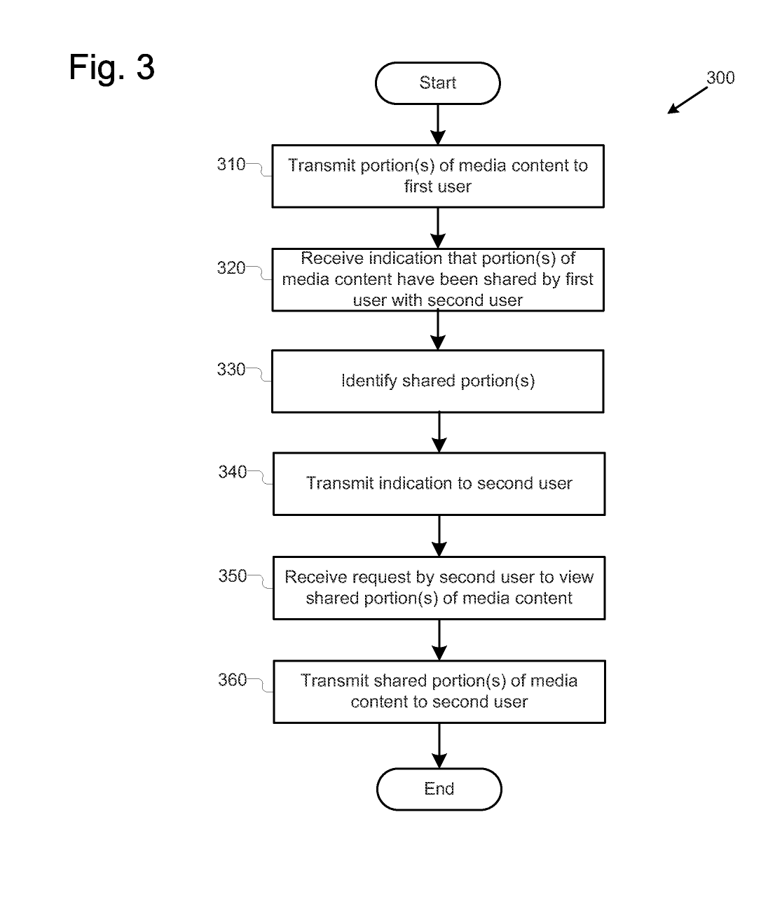

FIG. 3 depicts an example process 300 which may be performed by one or more servers of the media distribution network, for example content aggregator/distributor server(s) 104, or some other server. In embodiments, the server 104 may transmit media content such as content 102 to a client device such as content consumption device 108 at 310. A process such as process 200 may occur at the client device, wherein a user elects to share a portion of the content. In embodiments, the client device may transmit an indication that the client is sharing a portion of the content. The server may receive the indication that the portion of content has been shared at 320.

As noted above, the indication may include a variety of identifiers related to identification of the portion, identification of the sharing user, and/or identification of the target with which the portion may be shared. The server may use these one or more identifiers to identify the one or more shared portions of content and the one or more target(s) at 330.

The server may then transmit an indication to the second user at 340. In embodiments, the indication may be the same indication that was received by the server at 320. In other embodiments, the indication may be a different indication. In embodiments, the indication may be transmitted to a user device of the user via short message service (SMS), multimedia message service (MMS), email, a message within a social network service, a message with an online messaging or “chat” service, or some other method of message transfer. The indication may indicate to the second user than the first user has shared a portion of the content with the second user.

The server may then receive, from the second user, a request to access the shared portion of content at 350. In response to the request, the server may transmit the shared portion of content to the second user at 360. In other embodiments, the content may be stored in a different location than the server, and the server may transmit an address to access the portion to the second user. In some embodiments, the server may transmit an access key, for example an alphanumeric password or passcode, which the second user may use to access the portion as described in further detail below.

In some embodiments, instead of transmitting the indication to the second user at 340, the indication and/or the portion may be transmitted to a social network. For example, the first user may have a page on the social network, and the portion, or an Internet address for accessing the portion, may be posted on the page such that connections of the user in the social network such as friends or acquaintances may access the portion from the user's page on the social network.

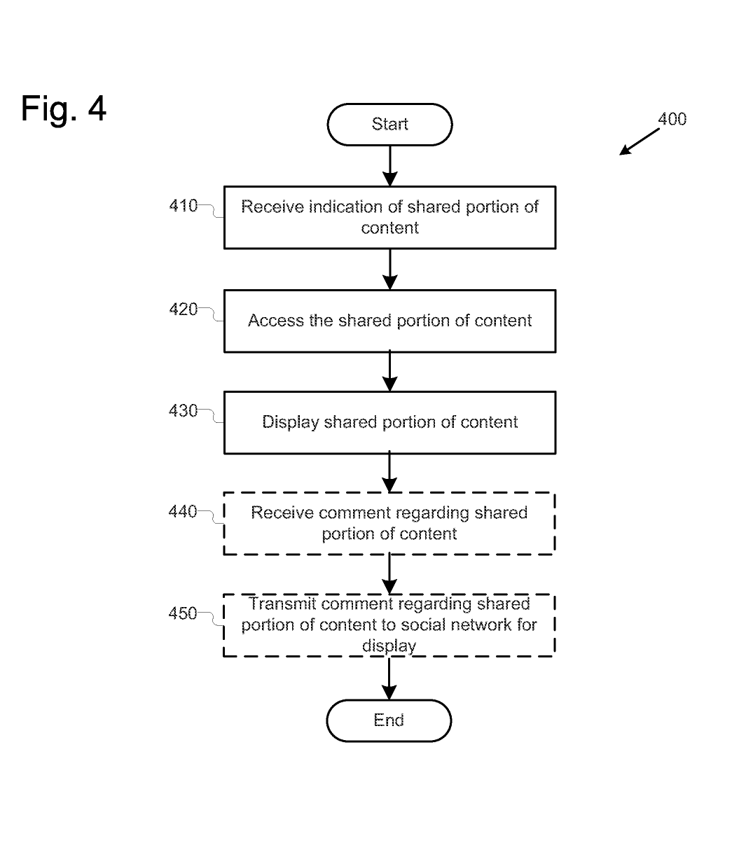

As noted, an indication that the first user has opted to share a portion of content with a second user may be transmitted to the second user. FIG. 4 depicts an example process 400 that may be performed by a user device of the second user. In embodiments, the user device of the second user may be one or more of a client consumption device such as client consumption device 108, a smartphone, a laptop computer, a personal digital assistant (PDA), a desktop computer, a tablet device, or some other user device of the second user.

In embodiments, the user device of the second user may receive an indication that the first user has shared a portion of the content with the second user at 410. As noted above, the indication may be received in a variety of formats including, but not limited to, an SMS message, an MMS message, an email, or other formats. In some embodiments, the indication may identify one or more of the first user, the second user, the contents of the shared portion, or some other information.

The second user may then access the shared portion of the content at 420. In some embodiments, the indication may have an Internet address such as a hypertext transfer protocol (HTTP) address. Upon clicking or otherwise activating the Internet address, the shared portion of the content may be delivered to the second user device, for example by content aggregator/distributor server 104 or some other server.

In other embodiments, the indication may additionally include an access key or some other identifying information. The second user may input a received Internet address into an Internet browser to access a server such as content aggregator/distributor server 104 or some other server. The second user may then input the received access key and, after verification or authentication, the portion of the shared content may be accessed by the second user. For example, the indication may be transferred to a portable user device such as a smartphone. The user may use an Internet browser of a desktop computer to go to the provided Internet address and input the access key so that the portion of the content may be accessed and retrieved by the second user to the desktop computer of the second user.

In some embodiments, the indication may be delivered to the user, and the user may access a social network, for example via a mobile or desktop user device. Upon accessing the social network, the user may be able to access the shared portion of content via the social network. For example, the second user may receive a notification that the first user has shared the portion of content with the second user via a social network, and then the second user may log onto the social network. Upon logging on, the second user may be able to directly access the shared portion of content through the social network.

After the second user access the shared portion of content at 420, the shared portion of content may be displayed at 430. For example, the shared portion of content may be displayed on a display of the user device, or some other display directly or remotely coupled with the user device.

In some embodiments, after the second user has viewed the shared portion of content, the second user device may receive, from the second user, a comment regarding the shared portion of content at 440. In some embodiments, the comment may be received by the user using an input device such as one or more of the input devices discussed above with respect to user input device 126. In other embodiments, the content may be spoken by the user and received by a microphone such as microphone 140.

After receiving the comment at 440, the comment may be transmitted to a social network for display by the social network 450. For example, if the user is already logged onto the social network, then the comment may be transmitted directly by the user device to the social network. Alternatively, if the user is not already logged onto the social network, then the comment may be transmitted by the second user device to a server of the social network along with authentication information of the second user such that the comment is displayed on a page of the social network. In some embodiments, the transmittal by the second user device may include information identifying the shared portion of content such as a name or unique identifier of the content.

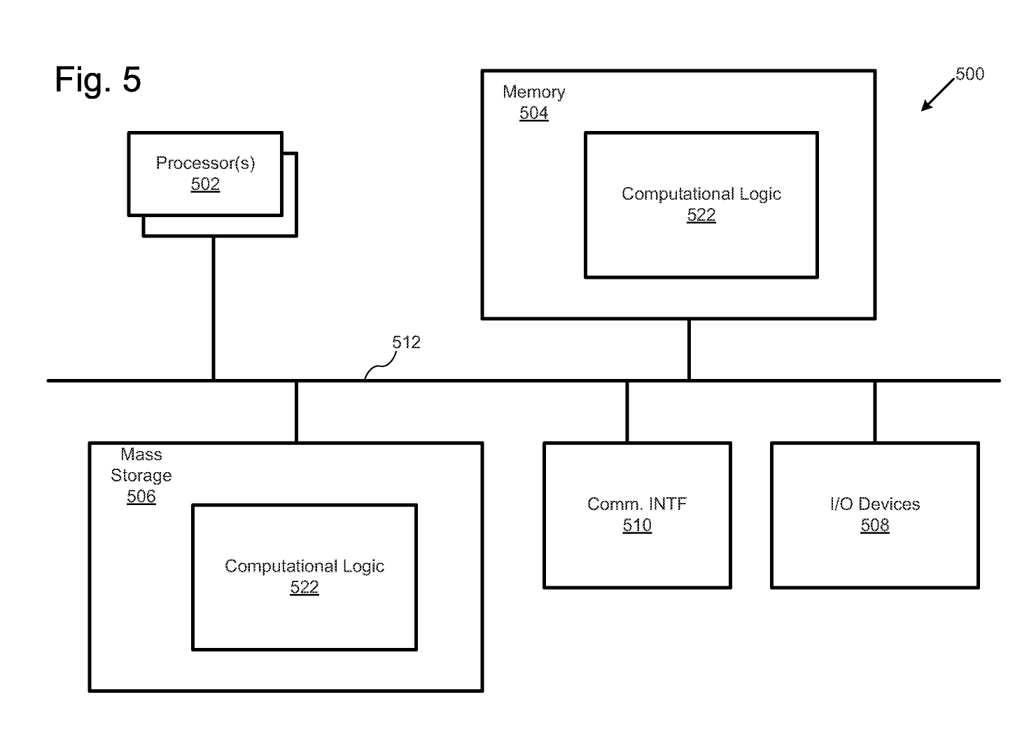

Referring now to FIG. 5, an example computer suitable for use for the arrangement of FIG. 1, in accordance with various embodiments, is illustrated. In embodiments, the computer 500 may be suitable for use as a stationary or mobile computing device. In embodiments, the computer 500 may be used as the user device of the second user. As shown, computer 500 may include one or more processors or processor cores 502, and system memory 504. For the purpose of this application, including the claims, the terms “processor” and “processor cores” may be considered synonymous, unless the context clearly requires otherwise. Additionally, computer 500 may include mass storage devices 506 (such as diskette, hard drive, compact disc read only memory (CD-ROM) and so forth), input/output devices 508 (such as display, keyboard, cursor control and so forth) and communication interfaces 510 (such as network interface cards, modems and so forth). The elements may be coupled to each other via system bus 512, which may represent one or more buses. In the case of multiple buses, they may be bridged by one or more bus bridges (not shown).

Each of these elements may perform its conventional functions known in the art. In particular, system memory 504 and mass storage devices 506 may be employed to store a working copy and a permanent copy of the programming instructions implementing the operations associated with content aggregator/distributor servers 104, second user device, and or content consumption device(s) 108. The various elements may be implemented by assembler instructions supported by processor(s) 502 or high-level languages, such as, for example, C, that can be compiled into such instructions.

The permanent copy of the programming instructions may be placed into mass storage devices 506 in the factory, or in the field, through, for example, a distribution medium (not shown), such as a compact disc (CD), or through communication interface 510 (from a distribution server (not shown)). That is, one or more distribution media having an implementation of the agent program may be employed to distribute the agent and program various computing devices.

The number, capability and/or capacity of these elements 510-512 may vary, depending on whether computer 500 is used as a content aggregator/distributor server 104 or a content consumption device 108, whether the content consumption device 108 is a stationary or mobile device, like a smartphone, computing tablet, ultrabook or laptop. Their constitutions are otherwise known, and accordingly will not be further described.

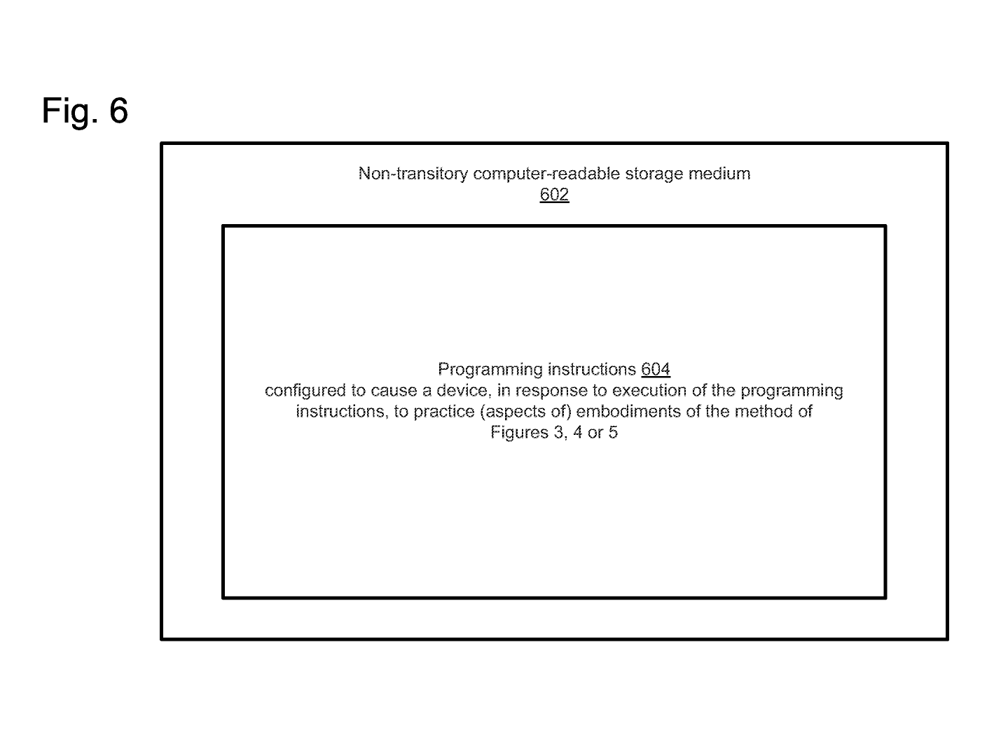

FIG. 6 illustrates an example non-transitory computer-readable storage medium having instructions configured to practice all or selected ones of the operations associated with content aggregator/distributor servers 104, content consumption device(s) 108, or a second user device; in accordance with various embodiments. As illustrated, non-transitory computer-readable storage medium 602 may include a number of programming instructions 604. Programming instructions 604 may be configured to enable a device, e.g., computer 500, in response to execution of the programming instructions, to perform, e.g., various operations of processes 200, 300 or 400. In alternate embodiments, programming instructions 604 may be disposed on multiple non-transitory computer-readable storage media 602 instead.

Referring back to FIG. 5, for one embodiment, at least one of processors 502 may be packaged together with computational logic 522 configured to practice aspects of processes 200, 300 or 400. For one embodiment, at least one of processors 502 may be packaged together with computational logic 522 configured to practice aspects of processes 200, 300 or 400 to form a System in Package (SiP). For one embodiment, at least one of processors 502 may be integrated on the same die with computational logic 522 configured to practice aspects of processes 200, 300 or 400. For one embodiment, at least one of processors 502 may be packaged together with computational logic 522 configured to practice aspects of processes 200, 300 or 400 to form a System on Chip (SoC). For at least one embodiment, the SoC may be utilized in, e.g., but not limited to, a computing tablet.

In some embodiments, one or more of the processors 502 or the computational logic 522 may comprise or be coupled with camera control logic configured to operate a camera, for example camera 138, according to aspects of processes 200, 300, or 400 above. In some embodiments, one or more of the processors 502 or the computational logic may comprise or be coupled with a recognition module configured to provide image recognition, for example facial recognition, according to aspects of processes 200, 300, or 400 above. In some embodiments, one or more of the processors 502 or the computational logic 522 may comprise or be coupled with microphone control logic configured to operate a microphone, for example microphone 140, according to aspects of process 200, 300, or 400 above.

The various embodiments of the present disclosure have been described including, but are not limited to the following examples.

Example 1 may include one or more computer readable media comprising instructions configured to cause a computing device, upon execution of the instructions by the computing device, to facilitate sharing of a portion of a content, wherein the computing device is caused to: transmit the content for presentation on a display device; receive, from a first user of the display device, a command to share the portion of the content with a second user, the portion of the content being less than all of the content; and facilitate transmission of an indication to the second user that the portion is available for viewing by the second user.

Example 2 may include the one or more computer readable media of example 1, wherein the command is a command by the first user during presentation of the content on the display device.

Example 3 may include the one or more computer readable media of example 2, wherein the command is a spoken command by the first user.

Example 4 may include the one or more computer readable media of example 2, wherein the command is received from a user-operated input device.

Example 5 may include the one or more computer readable media of example 2, wherein the portion is a first portion and the instructions are further configured to cause the computing device to receive the command during presentation of a second portion of the content to the first user, wherein the second portion is associated with a different time in the content than a time of presentation of the first portion to the first user.

Example 6 may include the one or more computer readable media of example 2, wherein the instructions are further configured to cause the computing device to receive the command while presentation of the content is paused.

Example 7 may include the one or more computer readable media of example 2, wherein the command is received at a first time of presentation of the content, and the portion begins at a second time of presentation of the content, the second time being before the first time.

Example 8 may include the one or more computer readable media of any of example 1-7, wherein the instructions are further configured to cause the computing device to: receive, from the first user, an indication of a start time of the portion; and receive, from the first user, an indication of a length of the portion or an end time of the portion.

Example 9 may include the one or more computer readable media of any of examples 1-7, wherein the second user is at a location remote from a location of the first user.

Example 10 may include the one or more computer readable media of any of examples 1-7, wherein a length of the portion is between 5 seconds and 30 seconds.

Example 11 may include the one or more computer readable media of any of examples 1-7, wherein the instructions are further configured to cause the computing device to: receive an identification of a location of the portion in the content; and receive an indication of the second user.

Example 12 may include an apparatus to facilitate sharing of a portion of a content, the apparatus comprising: a display; a presentation engine coupled with the display and configured to transmit the content to the display; and a user interface engine coupled with the presentation engine and configured to: receive, from a first user of the display device, a command to share the portion of the content with a second user, the portion having a length less than a length of the content; and facilitate transmission of an indication to the second user that the portion is available for viewing by the second user.

Example 13 may include the apparatus of example 12, wherein the command is a command by the first user during presentation of the content on the display device.

Example 14 may include the apparatus of example 13, wherein the command is a spoken command by the first user or the command is received from a user-operated input device.

Example 15 may include the apparatus of example 13, wherein the portion is a first portion, and the user interface engine is further configured to receive the command during presentation of a second portion of the content to the first user, wherein the second portion is associated with a later time in the content than a time of presentation of the first portion to the first user.

Example 16 may include apparatus of example 13, wherein the user interface engine is further configured to receive the command while presentation of the content is paused.

Example 17 may include the apparatus of example 13, wherein the command is received at a first time of presentation of the content, and the portion begins at a second time of presentation of the content, the second time being before the first time.

Example 18 may include the apparatus of example 13, wherein the user interface engine is further configured to: receive, from the first user, an indication of a start time of the portion; and receive, from the first user, an indication of an end time of the portion.

Example 19 may include the apparatus of any of examples 12-18, wherein the length of the portion is between 5 seconds and 30 seconds.

Example 20 may include the apparatus of any of examples 12-18, wherein the user interface engine is further configured to: receive an identification of a location of the portion in the content; and receive an indication of the second user.

Example 21 may include a method to facilitate sharing of a portion of a content, the method comprising: receiving, by a computing device of a second user, an indication that a first user has shared the portion of the content with the second user, the portion being less than all of the content; accessing, by the computing device, the portion; and retrieving, by the computing device, the portion of content.

Example 22 may include the method of example 21, wherein the portion has a length of between 5 seconds and 30 seconds; and wherein the content is video content.

Example 23 may include the method of examples 21 or 22, wherein the server is a server of a social network configured to be accessed by the first user and the second user; and wherein the indication is a text message, an email message, or a notification by the social network.

Example 24 may include the method of examples 23, further comprising: receiving, by the computing device, a comment related to the portion from the second user; and transmitting, by the computing device, the comment to the social network, wherein the social network is further configured to display the comment.

Example 25 may include the method of example 23, wherein the server is further configured to: transmit the content to the first user; receive, during presentation of the content, from the first user, a command to share a portion of the content that has been selected by the first user with the second user; and transmit the indication to the second user.

Example 26 may include a method to facilitate sharing of a portion of a content, the method comprising: transmitting, by a computing device, the content for presentation on a display device; receiving, by the computing device, from a first user of the display device, a command to share the portion of the content with a second user, the portion of the content being less than all of the content; and facilitating, by the computing device, transmission of an indication to the second user that the portion is available for viewing by the second user.

Example 27 may include the method of example 26, wherein the command is a command by the first user during presentation of the content on the display device.

Example 28 may include the method of example 27, wherein the command is a spoken command by the first user.

Example 29 may include the method of example 27, wherein the command is received from a user-operated input device.

Example 30 may include the method of example 27, wherein the portion is a first portion and further comprising receiving, by the computing device, the command during presentation of a second portion of the content to the first user, wherein the second portion is associated with a different time in the content than a time of presentation of the first portion to the first user.

Example 31 may include the method of example 27, further comprising receiving, by the computing device, the command while presentation of the content is paused.

Example 32 may include the method of example 27, wherein the command is received at a first time of presentation of the content, and the portion begins at a second time of presentation of the content, the second time being before the first time.

Example 33 may include the method of any of examples 26-32, further comprising: receiving, by the computing device, from the first user, an indication of a start time of the portion; and receiving, by the computing device, from the first user, an indication of a length of the portion or an end time of the portion.

Example 34 may include the method of any of examples 26-32, wherein the second user is at a location remote from a location of the first user.

Example 35 may include the method of any of examples 26-32, wherein a length of the portion is between 5 seconds and 30 seconds.

Example 36 may include the method of any of examples 26-32, further comprising: receiving, by the computing device, an identification of a location of the portion in the content; and receiving, by the computing device, an indication of the second user.

Example 37 may include an apparatus to facilitate sharing of a portion of a content, the apparatus comprising: means to transmit the content for presentation on a display device; means to receive, from a first user of the display device, a command to share the portion of the content with a second user, the portion of the content being less than all of the content; and means to facilitate transmission of an indication to the second user that the portion is available for viewing by the second user.

Example 38 may include the apparatus of example 37, wherein the command is a command by the first user during presentation of the content on the display device.

Example 39 may include the apparatus of example 38, wherein the command is a spoken command by the first user.

Example 40 may include the apparatus of example 38, wherein the command is received from a user-operated input device.

Example 41 may include the apparatus of example 38, wherein the portion is a first portion, and further comprising means to receive the command during presentation of a second portion of the content to the first user, wherein the second portion is associated with a different time in the content than a time of presentation of the first portion to the first user.

Example 42 may include the apparatus of example 38, further comprising means to receive the command while presentation of the content is paused.

Example 43 may include the apparatus of example 38, wherein the command is received at a first time of presentation of the content, and the portion begins at a second time of presentation of the content, the second time being before the first time.

Example 44 may include the apparatus of any of examples 37-43, further comprising: means to receive, from the first user, an indication of a start time of the portion; and means to receive, from the first user, an indication of a length of the portion or an end time of the portion.

Example 45 may include the apparatus of any of examples 37-43, wherein the second user is at a location remote from a location of the first user.

Example 46 may include the apparatus of any of examples 37-43, wherein a length of the portion is between 5 seconds and 30 seconds.

Example 47 may include the apparatus of any of examples 37-43, further comprising: means to receive an identification of a location of the portion in the content; and means to receive an indication of the second user.

Example 48 may include one or more computer readable media comprising instructions to share a portion of a content, the instructions configured to cause a computing device, in response to execution of the instructions by the computing device, to: receive an indication that a first user has shared the portion of the content with the second user, the portion being less than all of the content; access the portion; and retrieve the portion of content.

Example 49 may include the one or more computer readable media of example 48, wherein the portion has a length of between 5 seconds and 30 seconds; and wherein the content is video content.

Example 50 may include the one or more computer readable media of examples 48 or 49, wherein the server is a server of a social network configured to be accessed by the first user and the second user; and wherein the indication is a text message, an email message, or a notification by the social network.

Example 51 may include the one or more computer readable media of example 50, wherein the instructions are further configured to cause the computing device, in response to execution of the instructions by the computing device, to: receive a comment related to the portion from the second user; and transmit the comment to the social network, wherein the social network is further configured to display the comment.

Example 52 may include the one or more computer readable media of example 50, wherein the server is further configured to: transmit the content to the first user; receive, during presentation of the content, from the first user, a command to share a portion of the content that has been selected by the first user with the second user; and transmit the indication to the second user.

Example 53 may include an apparatus facilitate sharing of a portion of a content, the apparatus comprising: means to receive an indication that a first user has shared the portion of the content with the second user, the portion being less than all of the content; means to access the portion; and means to retrieve the portion of content.

Example 54 may include the apparatus of example 53, wherein the portion has a length of between 5 seconds and 30 seconds; and wherein the content is video content.

Example 55 may include the apparatus of examples 53 or 54, wherein the server is a server of a social network configured to be accessed by the first user and the second user; and wherein the indication is a text message, an email message, or a notification by the social network.

Example 56 may include the apparatus of example 55, further comprising: means to receive a comment related to the portion from the second user; and means to transmit the comment to the social network, wherein the social network is further configured to display the comment.

Example 57 may include the apparatus of example 55, wherein the server is further configured to: transmit the content to the first user; receive, during presentation of the content, from the first user, a command to share a portion of the content that has been selected by the first user with the second user; and transmit the indication to the second user.

Example 58 may include an apparatus to facilitate sharing of a portion of a content, the apparatus comprising: a display; a processor coupled to the display, the processor configured to: receive an indication that a first user has shared the portion of the content with the second user, the portion being less than all of the content; access the portion; and retrieve the portion of content.

Example 59 may include the apparatus of example 58, wherein the portion has a length of between 5 seconds and 30 seconds; and wherein the content is video content.

Example 60 may include the apparatus of examples 58 or 59, wherein the server is a server of a social network configured to be accessed by the first user and the second user; and wherein the indication is a text message, an email message, or a notification by the social network.

Example 61 may include the apparatus of example 60, wherein the processor is further configured to: receive a comment related to the portion from the second user; and transmit the comment to the social network, wherein the social network is further configured to display the comment.

Example 62 may include the apparatus of example 60, wherein the server is further configured to: transmit the content to the first user; receive, during presentation of the content, from the first user, a command to share a portion of the content that has been selected by the first user with the second user; and transmit the indication to the second user.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

What is claimed is:

1. One or more computer readable media comprising instructions configured to cause a computing device, upon execution of the instructions by the computing device, to facilitate sharing of a sample of a content, wherein the computing device is caused to:
transmit the content for presentation on a display device;
receive, from a first user of the display device, a command to share a portion of the content with a second user, the portion of the content being less than all of the content; and
facilitate transmission of an indication to the second user that the portion is available for viewing by the second user.

2. The one or more computer readable media of claim 1, wherein the command is a command by the first user during presentation of the content on the display device.

3. The one or more computer readable media of claim 2, wherein the command is a spoken command by the first user.

4. The one or more computer readable media of claim 2, wherein the command is received from a user-operated input device.

5. The one or more computer readable media of claim 2, wherein the portion is a first portion and the instructions are further configured to cause the computing device to receive the command during presentation of a second portion of the content to the first user, wherein the second portion is associated with a different time in the content than a time of presentation of the first portion to the first user.

6. The one or more computer readable media of claim 2, wherein the instructions are further configured to cause the computing device to receive the command while presentation of the content is paused.

7. The one or more computer readable media of claim 2, wherein the command is received at a first time of presentation of the content, and the portion begins at a second time of presentation of the content, the second time being before the first time.

8. The one or more computer readable media of claim 1, wherein the instructions are further configured to cause the computing device to:
receive, from the first user, an indication of a start time of the portion; and
receive, from the first user, an indication of a length of the portion or an end time of the portion.

9. The one or more computer readable media of claim 1, wherein the second user is at a location remote from a location of the first user.

10. The one or more computer readable media of claim 1, wherein a length of the portion is between 5 seconds and 30 seconds.

11. The one or more computer readable media of claim 1, wherein the instructions are further configured to cause the computing device to:
receive an identification of a location of the portion in the content; and
receive an indication of the second user.

12. An apparatus comprising:
a display;
a presentation engine coupled with the display and configured to transmit content to the display; and
a user interface engine coupled with the presentation engine and configured to:
receive, from a first user of the display device, a command to share a portion of the content with a second user, the portion having a length less than a length of the content; and
facilitate transmission of an indication to the second user that the portion is available for viewing by the second user.

13. The apparatus of claim 12, wherein the command is a command by the first user during presentation of the content on the display device.

14. The apparatus of claim 13, wherein the command is a spoken command by the first user or the command is received from a user-operated input device.

15. The apparatus of claim 13, wherein the portion is a first portion, and the user interface engine is further configured to receive the command during presentation of a second portion of the content to the first user, wherein the second portion is associated with a later time in the content than a time of presentation of the first portion to the first user.

16. The apparatus of claim 13, wherein the user interface engine is further configured to receive the command while presentation of the content is paused.

17. The apparatus of claim 13, wherein the command is received at a first time of presentation of the content, and the portion begins at a second time of presentation of the content, the second time being before the first time.

18. The apparatus of claim 13, wherein the user interface engine is further configured to:
receive, from the first user, an indication of a start time of the portion; and
receive, from the first user, an indication of an end time of the portion.

19. The apparatus of claim 12, wherein the length of the portion is between 5 seconds and 30 seconds.

20. The apparatus of claim 12, wherein the user interface engine is further configured to:
receive an identification of a location of the portion in the content; and
receive an indication of the second user.

21. A method comprising:
receiving, by a computing device of a second user, an indication that a first user has shared a portion of a content with the second, the portion being less than all of the content;
accessing, by the computing device, the portion; and
retrieving, by the computing device, the portion of content.

22. The method of claim 21, wherein the portion has a length of between 5 seconds and 30 seconds; and
wherein the content is video content.

23. The method of claim 21, wherein the server is a server of a social network configured to be accessed by the first user and the second user; and
wherein the indication is a text message, an email message, or a notification by the social network.

24. The method of claim 23, further comprising:
receiving, by the computing device, a comment related to the portion from the second user; and
transmitting, by the computing device, the comment to the social network, wherein the social network is further configured to display the comment.

25. The method of claim 23, wherein the server is further configured to:
transmit the content to the first user;
receive, during presentation of the content, from the first user, a command to share a portion of the content that has been selected by the first user with the second user; and transmit the indication to the second user.
